(19) United States
(12) Patent Application Publication
(10) Pub. No.: US 2010/0006751 A1
(43) Pub. Date: Jan. 14, 2010

(54) MINIATURIZED NON-RADIOACTIVE ELECTRON EMITTER

(75) Inventors: Wolfgang Bather, Lubeck (DE); Stefan Zimmermann, Reinfeld (DE)

Correspondence Address: MCGLEW & TUTTLE, PC, P.O. BOX 9227, SCARBOROUGH STATION, SCARBOROUGH, NY, 10510-9227, US

(73) Assignee: Dragerwerk AG & Co. KGaA, Lubeck (DE)

(21) Appl. No.: 12/423,182

(22) Filed: Apr. 14, 2009

(30) Foreign Application Priority Data
Jul. 9, 2008 (DE) 10 2008 032 333.0

(51) Int. Cl. H01J 49/00; G21G 4/00

(52) U.S. Cl. 250/281; 250/493.1; 977/765

(57) ABSTRACT

A novel, compact non-radioactive electron emitter is provided with a cylindrical shape and with an interior space (6), which forms a vacuum chamber. A substrate (7) forms the bottom of the arrangement with a plurality of field emitter tips (5) formed of carbon nanotubes in the interior space (6). The tips are fastened to the substrate. A layer structure forms the cover of the arrangement, having, from the outside towards the interior space (6), an electrode layer (13), which acts as a counterelectrode and is applied to a gas-impermeable and electron-permeable membrane (10). A substrate (11), which is left open in the form of a window (12) in the area above the field emitter tips (6), acts as a carrier substrate for the membrane (10) and the electrode layer (13). A circumferential wall (14) of the arrangement is formed by an electrically insulating material. The field emitter tips (5) and the electrode layer (13) are connected to a d.c. power source, so that the electrons exiting from the field emitter tips (5) are accelerated through the vacuum chamber, window (12) and the membrane (10) towards the electrode layer (13), pass through the electrode layer (13) and enter the ionization area (3) outside the electron emitter (1, 1′).

### CROSS REFERENCE TO RELATED APPLICATIONS

This application claims the benefit of priority under 35 U.S.C. §119 of German Patent Application DE 10 2008 032 333.0 filed Jul. 9, 2008, the entire contents of which are incorporated herein by reference.

### FIELD OF THE INVENTION

The present invention pertains to a non-radioactive electron emitter.

### BACKGROUND OF THE INVENTION

Radioactive electron emitters or electron sources are used, for example, for ion mobility spectrometers (IMS). IMS are suitable for the rapid measurement of very low concentrations of gaseous substances in air. They are used especially for detecting explosives, drugs, chemical warfare agents and highly toxic industrial gases. Other fields of application are the detection of volatile organic compounds in the breathing air, the monitoring of air in clean rooms in the semiconductor industry as well as the monitoring of workplaces. The characteristic essential assembly units of an IMS comprise the ionization area, separation area and detector. The ionization of the analytes is usually carried out by a chemical gas-phase reaction in air under atmospheric pressure. High-energy electrons at first ionize the nitrogen in the air. Subsequent chemical reactions in the gas phase then lead to the formation of stable positive and negative reactant ions, which can further react with analytes present to form positive and negative product ions. Radioactive nickel or tritium radiation emitters are usually used as electron sources. Despite the advantages of radioactive electron sources, such as low manufacturing costs, no energy consumption, small size and maintenance-free operation, non-radioactive ionization sources or electron emitters are increasingly of interest because of the risk potential and the requirements imposed in this connection for the operation.

Thus, the patents U.S. Pat. No. 5,969,349, U.S. Pat. No. 6,586,729 B2, U.S. Pat. No. 7,326,926 B2 as well as DE 10 2005 028 930 A1 disclose various non-radioactive ionization sources.

The ionization of the analytes to be detected by chemical reactions with reactant ions in the gas phase under atmospheric pressure is especially advantageous for various reasons. In particular, fragmentation of the analytes is unlikely in this manner, which has the desired consequence that the molecular structure of the analytes is preserved. This in turn leads to clear spectra and to better distinguishability of the analytes. Due to the high density of the analytes under atmospheric pressure, high sensitivity of detection is, moreover, obtained. High-energy free electrons, which are currently emitted usually by a radioactive radiation emitter as an electron source under atmospheric pressure into the ionization area, are necessary for forming the reactant ions.

### SUMMARY OF THE INVENTION

The object of the present invention is to embody a compact non-radioactive electron emitter of a simple design with low energy consumption, which makes it possible to emit electrons with the necessary energy and density into the atmospheric ionization area.

According to the invention, an electron emitter is provided comprising a cylindrical arrangement with a circumferential wall of the arrangement formed by an electrically insulating material. The circumferential wall defines an interior space which forms a vacuum chamber. A bottom substrate forms the bottom of said arrangement. A plurality of field emitter tips formed of carbon nanotubes are fastened to said bottom substrate in the interior space. A layer structure forms a cover of the arrangement. The layer structure has from the outside towards the interior space, an electrode layer forming a counterelectrode applied to a gas-impermeable and electron-permeable membrane. A layer substrate with an opening in an area above the field emitter tips providing a window forms a carrier substrate for the membrane and the electrode layer. A power source is provided with the field emitter tips and said electrode layer being connected to the power source, so that the electrons exiting from the field emitter tips are accelerated through the vacuum chamber, through said window and the membrane towards the electrode layer to pass through the electrode layer and enter an ionization area outside of the electron emitter.

The electron emitter may be combined with one of a mass spectrometer and an ion mobility spectrometer. The electron emitter comprises an electron source therefor.

The electron emitter may further comprise a spacer as part of said cylindrical arrangement for defining the interior space which forms the vacuum chamber. In this case a grid substrate may be provided with an extraction grid applied to the grid substrate. The extraction grid has an opening in the interior space between an extraction chamber and an accelerating chamber. The power source may include two power sources for setting the extraction voltage in the accelerating chamber with terminals of a first power source connected to the field emitter tips and to the extraction grid and with terminals of the second power source connected to the extraction grid and to the electrode layer.

An essential advantage of the electron emitter according to the invention follows from the use of the field emitter tips with a nanostructure especially on the basis of hydrocarbon nanotubes in the given arrangement.

Exemplary embodiments of the electron emitter according to the invention will be described below with reference to the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of an electron emitter;

FIG. 2 is an alternative embodiment of the bottom of the arrangement;

FIG. 3 is another alternative embodiment of the bottom of the arrangement;

FIG. 4 is another alternative embodiment of the bottom of the arrangement;

FIG. 5 is an alternative embodiment of the cover of the arrangement;

FIG. 6 is another alternative embodiment of the cover of the arrangement;

FIG. 7 is another alternative embodiment of the cover of the arrangement;

FIG. 8 is another alternative embodiment of the cover of the arrangement;

FIG. 9 is a schematic view of an alternative of the electron emitter according to FIG. 1;

FIG. 10 is an alternative embodiment for the substrate and the extraction grid;

FIG. 11 is another alternative embodiment for the substrate and the extraction grid; and

FIG. 12 is a schematic view of the electron emitter according to FIG. 1 with a shield.

### DESCRIPTION OF THE PREFERRED EMBODIMENTS

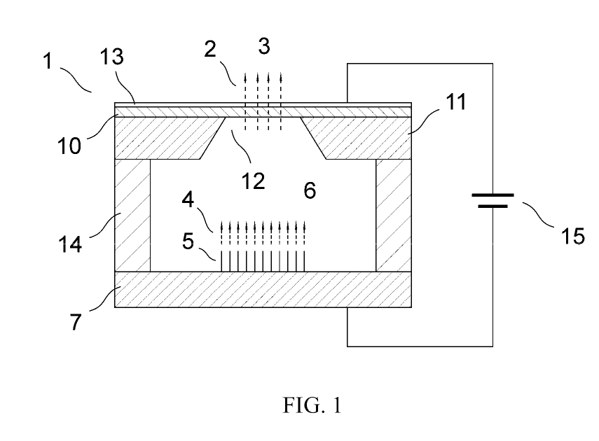

Referring to the drawings in particular, FIG. 1 schematically shows the design of an electron emitter 1, which is characterized by a simple and compact design, low energy consumption as well as high electron density and makes possible, unlike conventional field emitters, the emission of free electrons 2 into an ionization area 3 outside the arrangement under atmospheric pressure. Free electrons 4 are emitted at first at nanostructure field emitter tips 5 based on very high electric field intensities higher than 10⁹ V/m at the field emitter tips 5 and are accelerated in the interior space 6 designed as a vacuum chamber in the direction of the ionization area 3. The field emitter tips 5 are designed as carbon nanotubes, which are fastened to an electrically conductive or semiconductive substrate 7. Carbon nanotubes with a diameter smaller than 5 μm and especially smaller than 1 μm are especially suitable. Diameters of 10 μm to 100 μm are especially advantageous.

The length-to-diameter ratio of the carbon nanotubes should be at least greater than 2 and preferably greater than 20.

Lengths of 5 μm to 100 μm are especially advantageous.

Aluminum, highly doped silicon or silicon are especially suitable for use as substrate materials for the electrically conductive or semiconductive substrate 7.

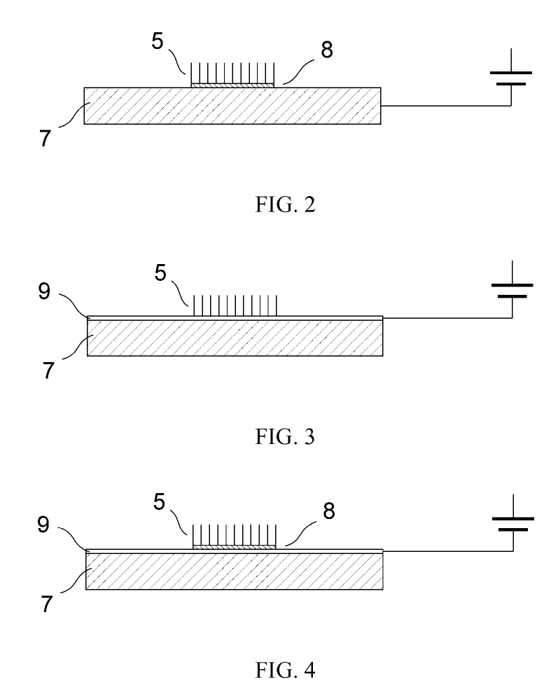

The use of carbon nanotubes as field emitter tips 5, which are fastened to an electrically conductive or semiconducting substrate 7, is advantageous. The substrate 7 is ideally a plate of a thickness of 0.5 mm to 2 mm made of, e.g., aluminum, highly doped, electrically conductive silicon or silicon with a base of 10×10 to 30×30 mm². The carbon nanotubes are usually deposited, as is described, for example, in U.S. Pat. No. 6,863,942 B2, on a catalyst layer 8 (FIG. 2). Suitable catalyst layers 8 consist of transition metals, alloys or oxides thereof, which are applied to the substrate 7 ideally in the form of nanoparticles. Especially advantageous are catalyst layers 8 of iron, cobalt or nickel particles as well as iron oxide particles. Suitable are carbon nanotubes with a diameter smaller than 5 μm and ideally smaller than 1 μm. Especially advantageous are diameters of 10 nm to 100 nm. The length-to-diameter ratio of the carbon nanotubes should be at least greater than 2 and ideally greater than 20. Lengths of 5 μm to 100 μm are especially favorable. To avoid shielding effects and for a high electron emission, adjacent carbon nanotubes should have a distance greater than twice their height. Densities of 10⁶ to 10⁹ carbon nanotubes per cm² are advantageous. Densities of 10⁶ carbon nanotubes per cm² are especially favorable. The area of the substrate 7 coated with carbon nanotubes is ideally centered centrally in relation to the substrate 7 and has an area smaller than 10×10 mm². Coating of the area on substrate 7 that is located opposite the window 12 in substrate 11 is especially advantageous. The carbon nanotubes are ideally distributed homogeneously over the area coated with carbon nanotubes. In case of a rotationally symmetrical design of the electrode emitter 1 and 1′ (FIG. 1 and FIG. 9, respectively), the edge lengths are defined as diameters. Various embodiments of the carbon nanotubes and carrier substrates are already available commercially, for example, from NanoLab, Newton, Mass. 02458, USA.

FIGS. 3 and 4 show alternative embodiments with an electrically non-conductive or semiconductive substrate 7, for example, one made of silicon. An additional electrode layer 9, for example, one made of aluminum, contacts the field emitter tips 5 or the catalyst layer 8.

A thin membrane 10, which is permeable to electrons but impermeable to gases, separates the interior space 6 forming a vacuum chamber from the ionization area 3, so that ionization of the analyte can take place in the ionization area 3, for example, and preferably under atmospheric pressure. Silicon nitride, which is applied stress-free and preferably with a thickness of 200 nm to 600 nm to a substrate 11, for example, one made of silicon, is an especially suitable membrane material. A window 12 with a dimension of, e.g., 1×1 mm, which is closed by the membrane 10 in a gas-tight manner, can be prepared in substrate 11 by structuring the substrate 11, for example, by means of wet chemical etching in a potassium hydroxide solution.

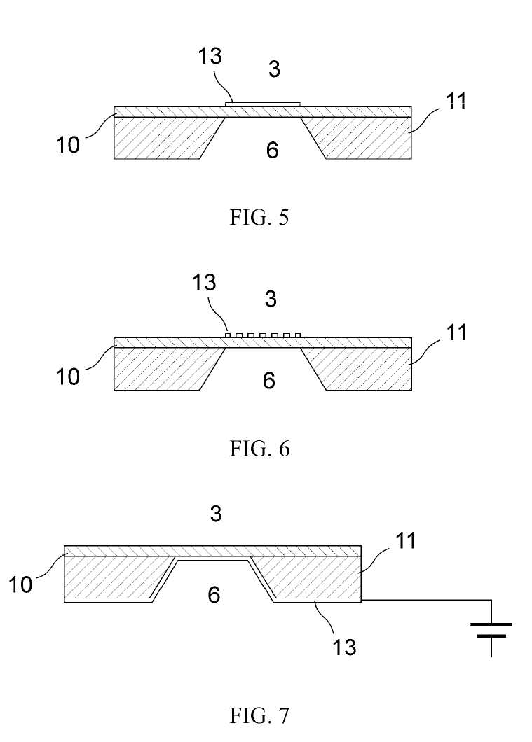

Due to the voltage applied from the outside, the electrons pass from the vacuum chamber into the ionization area 3 through the membrane 10 and a thin electrode layer 13 applied to the membrane 10. The electrode layer 13 is possibly limited in terms of area to the area of window 12 and/or made in the form of a grid, FIGS. 5 and 6. The depth of penetration of the electrons into the ionization area 3 depends, among other things, on the pressure in the ionization area 3 and the kinetic energy of the electrons 2 at the time of entry into the ionization area 3.

The depth of penetration in air is approx. 2 mm under atmospheric pressure and at an electron energy of 2 keV to 3 keV. Electron energies of 3 keV to 60 keV are favorable.

An aluminum layer with a thickness of 20 nm to 200 nm, which is deposited on membrane 10 and is optionally structured in the form of a grid, is suitable for use as the electrode layer 13.

The electrode layer 13 forms the counterelectrode to the field emitter tips 5, which counterelectrode is necessary for the field emission and acceleration of the electrons 4. The electrode layer 13 is preferably prepared as a flat or grid-like layer in the area of window 12 only in order to focus the electrons 4 in the direction of window 12.

The electrode layer 12 is applied in the embodiment shown in FIG. 7 on the side of the substrate 11 facing away from the ionization area 3 and is designed in one of the said variants.

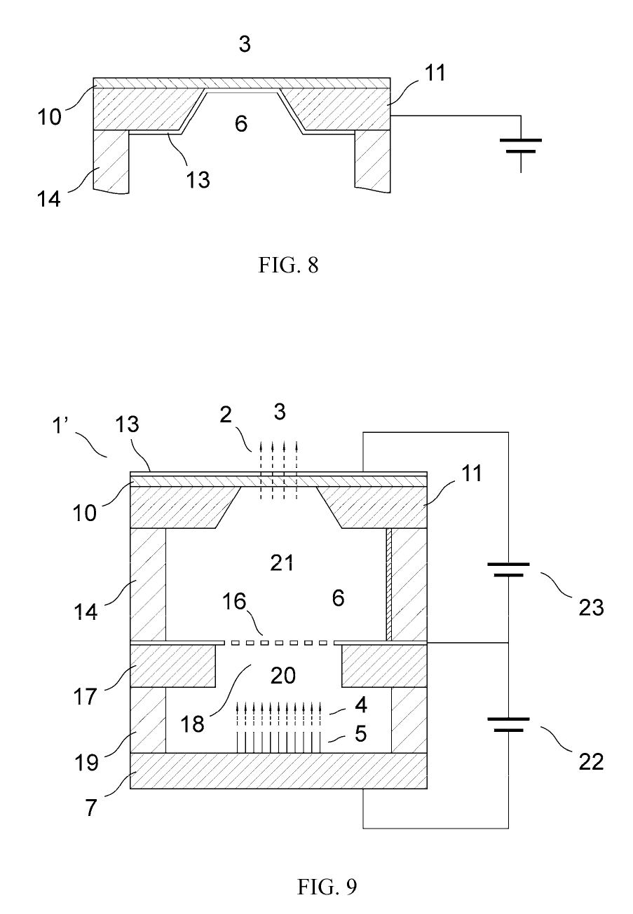

FIG. 8 shows another embodiment. The local extension of the electrode layer 13 including the feed lines is limited to the inner wall of the vacuum chamber in interior space 6. Substrate 11 is highly doped and electrically conductive or metallic in this embodiment. The circumferential wall 14 acting as a spacer (see FIG. 1), which preferably consists of glass and has a height of 2 mm to 20 mm, insulates the substrate 7 against the other substrate 11 or the electrode layer 13 acting as a counterelectrode. The potential difference between the field emitter tips 5 and the electrode layer 13 is generated by means of the external power source 15 (FIG. 1).

Integration of a metallic extraction grid 16, which is applied, as is shown, for example, in FIG. 9, to another substrate 17 with an opening 18, is advantageous for pulsed operation of the electron emitter 1′ according to FIG. 9. Suitable materials for the extraction grid 16 are gold, platinum or aluminum.

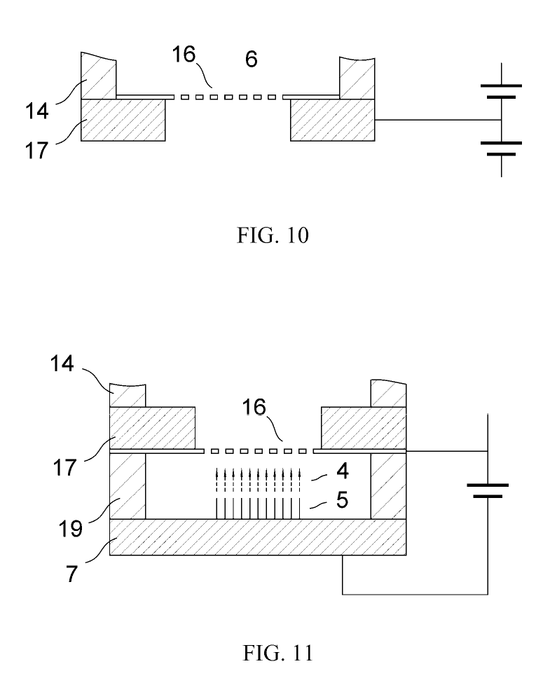

FIG. 10 shows an alternative embodiment of the extraction grid 16. The local extension of the extraction grid 16 including the feed lines is limited to the inner wall of the vacuum chamber.

The other substrate 17 is highly doped and electrically conductive or metallic in this embodiment corresponding to FIG. 9. A spacer 19, preferably one made of glass, insulates the substrate 17 against substrate 7 in the bottom area.

The electron emitter 1′ according to FIG. 9 has an accelerating chamber 21 separated from the extraction chamber 20. The extraction voltage and the accelerating voltage are set independently from one another with two power sources 22 and 23.

The individual components of the electron emitter 1 and 1′ are prepared individually separately and subsequently fitted together. The fitting together is carried out in one step or sequentially, at least the last fitting step taking place under vacuum at 10⁻³ to 10⁻⁷.

The components are especially preferably bonded anodically under vacuum. The distance between the extraction grid 16 and the field emitter structure is as short as possible for a high extraction field intensity at a low potential difference.

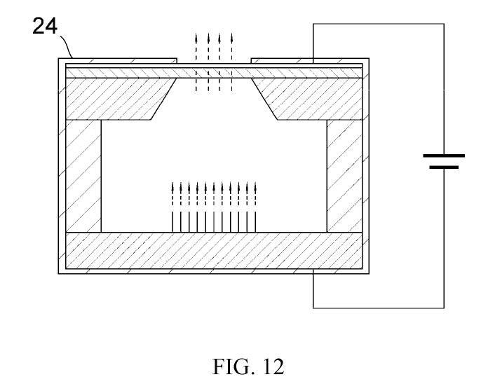

In an advantageous embodiment, the extraction grid 16 is applied according to FIG. 11 on the side of the substrate 17 facing the field emitter tips 5. Spacer 19 has especially a height of 50 μm to 500 μm. FIG. 12 shows another advantageous embodiment with a shield 24, which shields the electron emitter 1 or 1′ against external electric and magnetic fields. Suitable shielding materials consist of μ-metals or alloys thereof, such as nickel-iron alloys. Electron emitters 1, 1′ can be used, in principle, as electron or ionization sources in all measuring means that are based on a chemical gas-phase ionization of the analytes under atmospheric pressure. The electron emitters 1, 1′ described are especially suitable for use in mass spectrometers (MS) and ion mobility spectrometers (IMS). Especially advantageous is the arrangement shown with the associated possibility of obtaining a small size and simple design and of manufacture with gas-tight assembly under vacuum, so that no vacuum pump is necessary in the following measurement application.

The shape of the electron emitters is cylindrical with various cross-sectional shapes, especially with a circular or rectangular cross section.

While specific embodiments of the invention have been shown and described in detail to illustrate the application of the principles of the invention, it will be understood that the invention may be embodied otherwise without departing from such principles.

What is claimed is:

1. An electron emitter, comprising:
a cylindrical arrangement with a circumferential wall of the arrangement formed by an electrically insulating material, the circumferential wall defining an interior space which forms a vacuum chamber;
a bottom substrate forming the bottom of said arrangement;
a plurality of field emitter tips formed of carbon nanotubes, said field emitter tips being fastened to said bottom substrate in the interior space;
a layer structure forming a cover of said arrangement, said layer structure having from the outside towards the interior space, an electrode layer forming a counterelectrode applied to a gas-impermeable and electron-permeable membrane;
a layer substrate with an opening in an area above said field emitter tips to form a window, said layer substrate forming a carrier substrate for said membrane and said electrode layer;
a direct current power source, said field emitter tips and said electrode layer being connected to said power source, so that the electrons exiting from the field emitter tips are accelerated through the vacuum chamber, through said window and said membrane towards said electrode layer to pass through said electrode layer and enter an ionization area outside of electron emitter.

2. An electron emitter in accordance with claim 1, wherein the carbon nanotubes forming the field emitter tips have diameters of 10 nm to 100 nm and lengths of 5 μm to 100 μm.

3. An electron emitter in accordance with claim 1, wherein said bottom substrate is provided with a catalyst layer for the direct growth of the carbon nanotubes and wherein the catalyst layer contains nanoparticles of a transition metal or of an alloy of transition metals or oxidized nanoparticles of a transition metal or of an alloy of transition metals.

4. An electron emitter in accordance with claim 1, wherein said bottom substrate comprises at least one of aluminum, highly doped, electrically conductive silicon or silicon.

5. An electron emitter in accordance with claim 1, wherein said bottom substrate comprises an electrically non-conductive or semiconductive material and an additional conductive electrode layer for contacting the field emitter tips.

6. An electron emitter in accordance with claim 1, wherein said membrane is formed of silicon nitride and has a layer thickness of 200 nm to 600 nm.

7. An electron emitter in accordance with claim 1, wherein the substrate comprises aluminum, highly doped, electrically conductive silicon or silicon.

8. An electron emitter in accordance with claim 1, wherein the electrode layer is one of limited to the window and formed as a grid.

9. An electron emitter in accordance with claim 1, wherein the electrode layer comprises an aluminum layer with a thickness of 20 nm to 200 nm.

10. An electron emitter in accordance with claim 1, wherein the electrode layer is applied on a side of the substrate and of the membrane pointing towards the field emitter tips.

11. An electron emitter in accordance with claim 1, wherein the electrode layer is limited to the inner wall of the vacuum chamber and said layer substrate is a highly doped, electrically conductive semiconductor material or a metal.

12. An electron emitter in accordance with claim 1, wherein the components are bonded anodically under vacuum.

13. An electron emitter, comprising:
a cylindrical arrangement with a circumferential wall and a spacer of the arrangement formed by an electrically insulating material, the circumferential wall and spacer defining an interior space which forms a vacuum chamber;
a bottom substrate forming the bottom of said arrangement;
a plurality of field emitter tips formed of carbon nanotubes, said field emitter tips being fastened to said bottom substrate in the interior space;
a layer structure forming a cover of said arrangement, said layer structure having from the outside towards the interior space, an electrode layer forming a counterelectrode applied to a gas-impermeable and electron-permeable membrane;
a layer substrate with an opening forming a window in the area above the field emitter tips, said layer substrate forming a carrier substrate for said membrane and said electrode layer;
a grid substrate;
an extraction grid applied to said grid substrate, said extraction grid having an opening in the interior space between an extraction chamber and an accelerating chamber;
two power sources for setting the extraction voltage in the accelerating chamber with terminals of a first power source connected to said field emitter tips and to said extraction grid and with terminals of said second power source connected to said extraction grid and to said electrode layer.

14. An electron emitter in accordance with claim 13, wherein the carbon nanotubes forming the field emitter tips have diameters of 10 nm to 100 nm and lengths of 5 μm to 100 μm.

15. An electron emitter in accordance with claim 13, wherein said bottom substrate is provided with a catalyst layer for the direct growth of the carbon nanotubes and wherein the catalyst layer contains nanoparticles of a transition metal or of an alloy of transition metals or oxidized nanoparticles of a transition metal or of an alloy of transition metals.

16. An electron emitter in accordance with claim 13, wherein said bottom substrate comprises at least one of aluminum, highly doped, electrically conductive silicon or silicon.

17. An electron emitter in accordance with claim 13, wherein said bottom substrate comprises an electrically non-conductive or semiconductive material and an additional conductive electrode layer for contacting the field emitter tips.

18. An electron emitter in accordance with claim 13, wherein said membrane is formed of silicon nitride and has a layer thickness of 200 nm to 600 nm.

19. An electron emitter in accordance with claim 13, wherein the substrate comprises aluminum, highly doped, electrically conductive silicon or silicon.

20. An electron emitter in accordance with claim 13, wherein the electrode layer is one of limited to the window and formed as a grid.

21. An electron emitter in accordance with claim 13, wherein the electrode layer comprises an aluminum layer with a thickness of 20 nm to 200 nm.

22. An electron emitter in accordance with claim 13, wherein the electrode layer is applied on a side of the substrate and of the membrane pointing towards the field emitter tips.

23. An electron emitter in accordance with claim 13, wherein the electrode layer is limited to the inner wall of the vacuum chamber and said layer substrate is a highly doped, electrically conductive semiconductor material or a metal.

24. An electron emitter in accordance with claim 13, wherein said extraction grid comprises gold, platinum and/or aluminum.

25. An electron emitter in accordance with claim 13, wherein said grid substrate comprises aluminum, highly doped, electrically conductive silicon or silicon.

26. An electron emitter in accordance with claim 13, wherein said extraction grid is limited to an inner wall of the vacuum chamber and said grid substrate is a highly doped, electrically conductive semiconductor material or a metal.

27. An electron emitter in accordance with claim 13, wherein the extraction grid (16) is applied on a side of said grid substrate pointing towards the field emitter tips.

28. An electron emitter in accordance with claim 13, wherein said circumferential wall and said spacer are made of glass.

29. An electron emitter in accordance with claim 13, wherein the components are bonded anodically under vacuum.

30. An electron emitter in accordance with claim 13, further comprising an outer shield comprising one or more metals and a nickel-iron alloy.

31. A spectrometer device comprising:
an electron emitter comprising a cylindrical arrangement with a circumferential wall of the arrangement formed by an electrically insulating material, the circumferential wall defining an interior space which forms a vacuum chamber, a bottom substrate forming the bottom of said arrangement, a plurality of field emitter tips formed of carbon nanotubes, said field emitter tips being fastened to said bottom substrate in the interior space, a layer structure forming a cover of said arrangement, said layer structure having from the outside towards the interior space, an electrode layer forming a counterelectrode applied to a gas-impermeable and electron-permeable membrane, a layer substrate with an opening in an area above said field emitter tips to form a window, said layer substrate forming a carrier substrate for said membrane and said electrode layer, a power source, said field emitter tips and said electrode layer being connected to said power source, so that the electrons exiting from the field emitter tips are accelerated through the vacuum chamber, through said window and said membrane towards said electrode layer to pass through said electrode layer and enter an ionization area outside of electron emitter; and
one of a mass spectrometer and an ion mobility spectrometer with said electron emitter comprising an electron source therefor.

32. A spectrometer device according to claim 31, wherein said electron emitter further comprises:
a spacer as part of said cylindrical arrangement for defining said interior space which forms the vacuum chamber;
a grid substrate;
an extraction grid applied to said grid substrate, said extraction grid having an opening in the interior space between an extraction chamber and an accelerating chamber; and wherein
said power source includes two power sources for setting the extraction voltage in the accelerating chamber with terminals of a first power source connected to said field emitter tips and to said extraction grid and with terminals of said second power source connected to said extraction grid and to said electrode layer.
